(19) United States
(12) Patent Application Publication
(10) Pub. No.: US 2006/0206764 A1
(43) Pub. Date: Sep. 14, 2006

(54) Memory reliability detection system and method

(75) Inventors: Ying-Chih Lu, Taipei (TW); Meng-Hua Cheng, Taipei (TW); Chun-Yi Lee, Taipei (TW); Chia-Hsing Lee, Taipei (TW); Chi-Tsung Chang, Taipei (TW); Ling-Hung Yu, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/080,865

(22) Filed: Mar. 11, 2005

(51) Int. Cl. G06F 11/00

(52) U.S. Cl. 714/36

(57) ABSTRACT

A memory reliability detection system and a memory reliability detection method are applied in a computer device to perform a detection process on a motherboard according to a basic input/output system (BIOS) program during power-on of the computer device, so as to allow the computer device to successfully enter an operating system and steadily operate as well as perform an initialization procedure according to the BIOS program. The computer device is allowed to read a parameter of a dual in-line memory module (DIMM) on the motherboard to perform the detection process. If a detection result does not satisfy a predetermined requirement, the DIMM is problematic and recorded in a storage unit, such that the computer device can identify and ignore the problematic DIMM according to the record after power-on, thereby preventing an influence on operation stability of the computer device due to reading the problematic DIMM during operation.

### FIELD OF THE INVENTION

The present invention relates to memory reliability detection systems and methods, and more particularly, to a memory reliability detection system and method for detecting whether there is a problem in a dual in-line memory module (DIMM).

### BACKGROUND OF THE INVENTION

Computers have been used more and more extensively in personal life and work, and become almost an essential daily necessity nowadays. The popular usage of computers not only accelerates the development of computer technology but also promotes the progress of network technology, thereby making computer manufacturers more actively endeavor to develop servers.

Regardless of improvement in operation efficiency of personal computers or servers, the most important thing to a user is reliability and stability of systems, and the reliability and stability of systems are usually affected by memories.

For a dual in-line memory module (DIMM) used by a current computer device, a basic input/output system (BIOS) program of the computer device has to be set in accordance with memory parameters provided by a DIMM manufacturer, wherein the memory parameters refer to serial presence detect (SPD) data stored in an electrically erasable programmable read-only memory (EEPROM) built in the DIMM. Therefore, an initialization procedure is performed on the DIMM on a motherboard by the BIOS program when the computer device is powered on, so as to allow the computer device to enter an operating system successfully. However, due to some reasons, for example, the SPD data of DIMM being damaged by computer viruses, problems occurring in an 12C transmission path of DIMM, or recording an incorrect message during a burning process for the SPD data of DIMM, etc., the SPD data of DIMM read by the BIOS program are incorrect data content after the computer device is powered on, thereby easily causing system hanging during a memory initialization stage or unstable system operation after entering the operating system.

Therefore, the problem to be solved is how to detect whether SPD data of a DIMM are correct so as to effectively prevent errors of the SPD data of DIMM and an influence on the reliability of system operation.

### SUMMARY OF THE INVENTION

In order to solve the foregoing drawbacks in the prior art, a primary objective of the present invention is to provide a memory reliability detection system and method, which can detect reliability of a dual in-line memory module (DIMM) in a computer device by reading serial presence detect (SPD) data of the DIMM, so as to eliminate an influence on operation stability of the computer device due to reading a problematic DIMM.

In accordance with the above and other objectives, the present invention proposes a memory reliability detection system and method. The memory reliability detection system in the present invention is used in a computer device so as to allow the computer device to perform a detection process on a motherboard according to a basic input/output system (BIOS) program during a power-on procedure of the computer device, such that the computer device can successfully enter an operating system and steadily operate. The memory reliability detection system comprises: at least one dual in-line memory module (DIMM) having a storage block; a controller electrically connected to the DIMM, such as an 12C bus controller, for performing read/write control on serial presence detect (SPD) data of the DIMM; and a detection module for allowing the controller to read a parameter of the DIMM to perform the detection process during an initialization procedure performed by the BIOS program, wherein if a detection result does not satisfy a predetermined requirement, the DIMM is problematic and recorded in a storage unit, such that the computer device can identify the problematic DIMM according to the record, and ignores the problematic DIMM after power-on of the computer device, so as to prevent an influence on operation stability of the computer device due to reading the problematic DIMM during operation.

The present invention also proposes a memory reliability detection method, which is applied in a computer devices at least having a storage unit, so as to allow the computer device to perform a detection process on a motherboard according to a BIOS program during a power-on procedure of the computer device, such that the computer device can successfully enter an operating system and steadily operate. The memory reliability detection method comprises the steps of: having the computer device perform an initialization procedure in accordance with the BIOS program; and having the computer device read a parameter of a DIMM on the motherboard to perform the detection process, wherein if a detection result does not satisfy a predetermined requirement, the DIMM is problematic and recorded in the storage unit, such that the computer device can identify the problematic DIMM according to the record stored in the storage unit, and ignores the problematic DIMM after power-on of the computer device so as to prevent an influence on operation stability of the computer device due to reading the problematic DIMM during operation.

### BRIEF DESCRIPTION OF THE DRAWINGS

The present invention can be more fully understood by reading the following detailed description of the preferred embodiments, with reference made to the accompanying drawings, wherein:

FIG. 1 is a block schematic diagram showing basic structure of a memory reliability detection system according to the present invention; and

FIG. 2 is a flowchart showing steps of a memory reliability detection method according to the present invention.

### DETAILED DESCRIPTION OF THE PREFERRED EMBODIMENTS

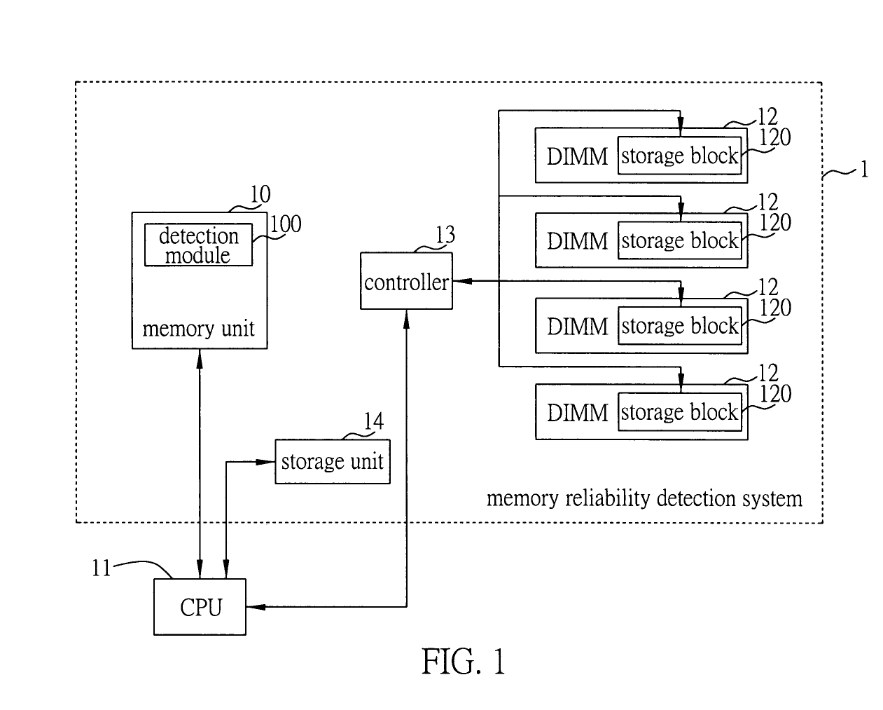

FIG. 1 is a block schematic diagram showing basic structure of a memory reliability detection system proposed in the present invention. In this embodiment, the memory reliability detection system 1 according to the present invention is applied in a computer device, for instance, a server, personal computer, etc., so as to allow the computer device to perform detection on a motherboard (not shown) according to a basic input/output system (BIOS) program during a power-on procedure of the computer device, and allow the computer device to successfully enter an operating system and operate steadily when the BIOS program completes a power-on self test (POST). Since the foregoing BIOS program and POST procedure of the computer device are essential component and procedure for an ordinary computer system before operation, and are well known for a person skilled in the computer art, thus the operational functionality and internal structure thereof are not to be further described hereinafter.

As shown in FIG. 1, the memory reliability detection system 1 in the present invention comprises: a detection module 100, a plurality of dual in-line memory modules (DIMMs) 12, a controller 13, and a storage unit 14. It should be noted that the computer device applied with the memory reliability detection system in the present invention has other functional units, however, to simplify the drawing and description, only the structure or component relating to the present invention is shown, for example, hardware structure such as Southbridge and Northbridge is not shown in the drawing. Moreover, the number of DIMMs 12 is not limited to four as shown in this embodiment, but can be flexibly adjusted to be e.g. six or eight, etc. in accordance with the practical implementation.

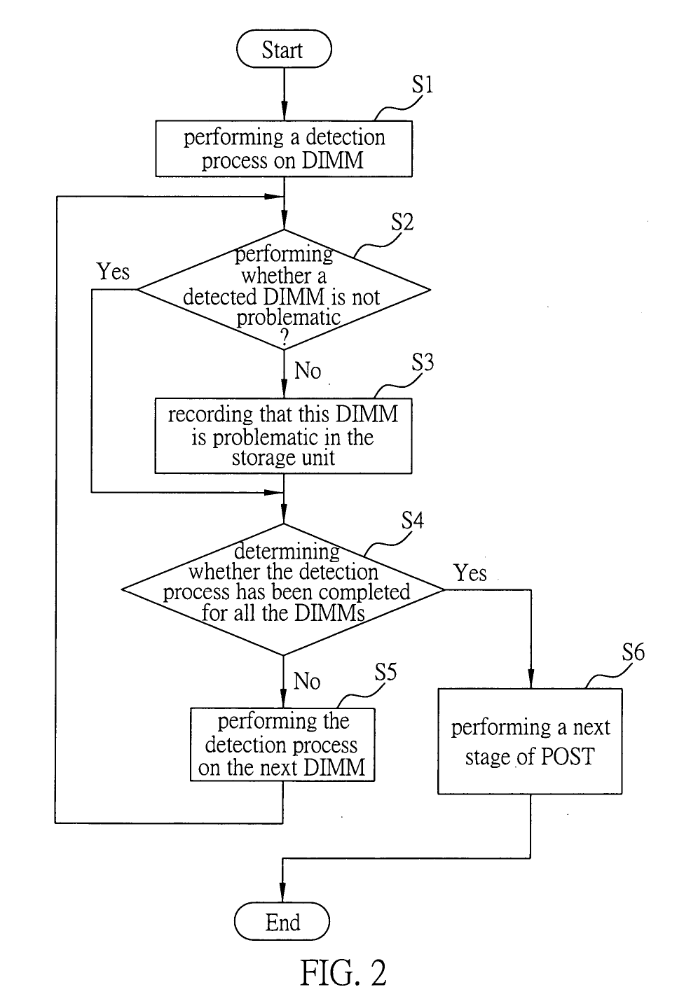

The detection module 100 is for example a detection program. In this embodiment, the detection module 100 is built in a memory unit 10 for storing the BIOS program (not shown), so as to allow a central processing unit (CPU) 11 of the computer device to perform an initialization procedure according to the BIOS program pre-stored in the memory unit 10 after power-on of the computer device and also perform a detection process on each of the DIMMs 12 in accordance with the detection module 100 built in the memory unit 10 (to be described later with reference to FIG. 2).

The storage unit 14, such as a complementary metal oxide semiconductor (CMOS) or nonvolatile random access memory (NVRAM), is used to record a problematic DIMM. The DIMMs 12 each has a storage block 120 such as an electrically erasable programmable read-only memory (EEPROM) for storing DIMM parameters i.e. serial presence detect (SPD) data. The controller 13 such as a 12C bus controller is used to perform read/write control on the SPD data of the plurality of DIMMs 12. The controller 13 is connected to the CPU 11, such that the controller 13 performing read/write control on the SPD data of the DIMMs 12 is controlled by the CPU 11. When the computer device is powered on and the CPU 11 executes the BIOS program (not shown) to perform the initialization procedure, the CPU 11 allows the controller 13 to perform the detection process on the SPD data stored in the storage block 120 of each of the DIMMs 12 in accordance with a processing procedure set by the detection module 100. If a detection result does not satisfy a predetermined requirement, it indicates that there is a problem incurred in the DIMM. This problematic DIMM is then recorded in the storage unit 14, such that the problematic DIMM (for example being damaged, SPD data of DIMM being damaged by computer viruses, problems occurring in an 12C bus transmission path of DIMM, or recording an incorrect message during a burning process for SPD data of DIMM) can be identified during subsequent memory initialization.

The memory reliability detection system 1 in the present invention further comprises an alarm module (not shown), such as a light emitting diode or buzzer, which is electrically connected to the CPU 11. When it is detected that there in a problem in the DIMM 12, the alarm module sends an alarm signal to notify a system administrator that the DIMM 12 is problematic.

The memory reliability detection system 1 in the present invention further comprises a baseboard management controller (BMC) (not shown), which is electrically connected to the CPU 11. When it is detected that there in a problem in the DIMM 12, the BMC sends a message indicating the DIMM 12 is problematic to a distant server via a network system (e.g. Internet or a local area network) to inform a system administrator at the distant server that the DIMM 12 is problematic.

FIG. 2 shows steps of a memory reliability detection method according to the present invention in the use of the memory reliability detection system 1. As shown in FIG. 2, when the computer device is powered on and the BIOS program starts to perform an initialization procedure on DIMMs 12 located on a motherboard, the method proceeds to step S1. In step S1, the CPU 11 performs a detection process on the DIMMs 12 via the controller 13 in accordance with the detection module 100 of the memory unit 10. The detection process refers to checksum being performed on SPD data of the DIMMs 12, wherein the checksum is performed by summing up values of SPD[0], SPD[1], SPD[2], SPD[3] to SPD[62] and comparing the sum of values with SPD[63]. Then, the method proceeds to step S2.

In step S2, the CPU 11 determines whether the sum of values of SPD[0] to SPD[62] from step S1 is equal to SPD[63]. If yes, the method proceeds to step S4; otherwise, the method proceeds to step S3.

In step S3, when the CPU 11 determines that the sum of values of SPD[0] to SPD[62] from step S1 is not equal to SPD[63], it indicates that there is a problem incurred in the DIMM 12. The problematic DIMM 12 is then recorded in the storage unit 14, such that the computer device during subsequent reading can identify the problematic DIMM, thereby preventing an influence on operation of the computer device due to reading the problematic DIMM. Then, the method proceeds to step S4.

In step S4, the CPU 11 determines whether the detection process has been completed for all the DIMMs 12. If yes, the method proceeds to step S6; otherwise, the method proceeds to step S5.

In step S5, the CPU 11 performs the detection process on the next DIMM 12, and the method returns to step S2.

In step S6, since the computer device has completed the detection process for all the DIMMs 12, a next stage of POST is performed.

Therefore, by the memory reliability detection system and method in the present invention for use in a computer device, when a BIOS program starts to perform an initialization procedure on DIMMs, SPD data of each of the DIMMs are read and detected, so as to prevent access actions from being performed on problematic DIMMs, and thus assure the reliability and stability of system operation of the computer device.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A memory reliability detection system applied in a computer device to allow the computer device to perform a detection process on a motherboard according to a basic input/output system program in a power-on procedure of the computer device so as to allow the computer device to successfully enter an operating system and steadily operate, the memory reliability detection system comprising:
at least one dual in-line memory module having a storage block;
a storage unit;
a controller electrically connected to the dual in-line memory module and for performing read/write control on serial presence detect data of the dual in-line memory module; and
a detection module for allowing the controller to read a parameter of the dual in-line memory module to perform the detection process in an initialization procedure performed by the basic input/output system program, wherein if a result of the detection process does not satisfy a predetermined requirement, the dual in-line memory module is problematic and recorded in the storage unit, so as to allow the computer device to identify the problematic dual in-line memory module in accordance with the record stored in the storage unit and ignore the problematic dual in-line memory module after the power-on procedure to prevent an influence on operation stability of the computer device due to reading the problematic dual in-line memory module during operation.

2. The memory reliability detection system of claim 1, wherein the detection process is performed by the detection module on the serial presence detect data of the dual in-line memory module.

3. The memory reliability detection system of claim 2, wherein the detection process performed by the detection module refers to checksum being performed on the serial presence detect data of the dual in-line memory module.

4. The memory reliability detection system of claim 3, wherein the checksum refers to summing up values of SPD[0] to SPD[62] and determining whether the sum of values is equal to SPD[63], and if the sum of values is equal to SPD[63], it indicates that the dual in-line memory module operates normally.

5. The memory reliability detection system of claim 1, wherein the storage block of the dual in-line memory module comprises an electrically erasable programmable read-only memory.

6. The memory reliability detection system of claim 1, wherein the detection module is built in a memory for storing the basic input/output system program.

7. A memory reliability detection method applied in a computer device at least having a storage unit to allow the computer device to perform a detection process on a motherboard according to a basic input/output system program in a power-on procedure of the computer device so as to allow the computer device to successfully enter an operating system and steadily operate, the memory reliability detection method comprising the steps of:
having the computer device perform an initialization procedure according to the basic input/output system program; and
having the computer device read a parameter of a dual in-line memory module on the motherboard to perform the detection process, wherein if a result of the detection process does not satisfy a predetermined requirement, the dual in-line memory module is problematic and recorded in the storage unit, so as to allow the computer device to identify the problematic dual in-line memory module in accordance with the record stored in the storage unit and ignore the problematic dual in-line memory module after the power-on procedure to prevent an influence on operation stability of the computer device due to reading the problematic dual in-line memory module during operation.

8. The memory reliability detection method of claim 7, wherein the detection process is performed by the computer device on serial presence detect data of the dual in-line memory module.

9. The memory reliability detection method of claim 8, wherein the detection process performed by the computer device refers to checksum being performed on the serial presence detect data of the dual in-line memory module.

10. The memory reliability detection method of claim 9, wherein the checksum refers to summing up values of SPD[0] to SPD[62] and determining whether the sum of values is equal to SPD[63], and if the sum of values is equal to SPD[63], it indicates that the dual in-line memory module operates normally.

11. The memory reliability detection method of claim 7, wherein the dual in-line memory module has a storage block comprising an electrically erasable programmable read-only memory.

12. The memory reliability detection method of claim 7, wherein the detection process performed by the computer device is implemented by a detection program built in a memory for storing the basic input/output system program.
